(19) United States
(12) Patent Application Publication
(10) Pub. No.: US 2015/0315806 A1
(43) Pub. Date: Nov. 5, 2015

(54) RESTING PLACE VASE HOOK AND SYSTEM, AND METHOD OF USE THEREOF

(71) Applicant: Alfred William Heard, Cumming, GA (US)

(72) Inventor: Alfred William Heard, Cumming, GA (US)

(21) Appl. No.: 14/267,536

(22) Filed: May 1, 2014

(51) Int. Cl. E04H 13/00; F21V 21/08; A61G 99/00; F21S 9/03; F16M 13/02; F16M 11/00

(52) U.S. Cl. CPC E04H 13/001; F16M 13/022; F16M 11/00; A61G 99/00; F21S 9/03; F21V 21/0832

(57) ABSTRACT

A resting place vase hook includes an attachment means and at least one arm. The attachment means is attachable to a vase. The arms extend from the attachment means and each have a hook. Whereby, the hooks being operable to hang an adornment in an elevated position.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field

The disclosure generally relates to resting place decorations, like vases and flowers gravestones or resting place markers.

2. Description of Related Art

Mourning and remembering the passing of our family, friends, and loved ones is a tough, but important part of our lives and dealing with undesired losses. Visiting the grave site of a family member or friend may be desirable for many people to bring them comfort, causing them to remember the deceased, their life, and their memories. One mark of respect and memory is often to decorate the resting place or grave site with appropriate items, like vases filled with flowers or other desired objects or adornments.

Vases filled with flowers or other adornments are typically put on top of the resting place, grave site, grave stone, marker, or the like. One problem associated with putting vases on top of the resting place may be the limited space. Another problem may be the requirement that no flowers or adornments may be on the ground, which may be requirements at cemeteries for easier lawn maintenance around the resting place. Another problem with putting vases on top of the resting place is the limited visibility, especially in the dark.

Therefore, it is readily apparent that there is a recognizable unmet need for a resting place vase hook that is compact, keeps flowers and other adornments off the ground, and may provide additional visibility.

### SUMMARY

Briefly described, in a preferred embodiment, the present apparatus and method overcomes the above-mentioned disadvantages and meets the recognized need for such a device by providing a resting place vase hook and method of use thereof that may be compact, may keep flowers and other objects off the ground, and may provide additional visibility.

The present apparatus and method includes a resting place vase hook, wherein the resting place vase hook includes an attachment means and at least one arm. The attachment means may be attachable to a vase. The arm or arms may extend from the attachment means and may have a hook or plurality of hooks. Whereby, the hooks being operable to hang an adornment or adornments in an elevated position.

One feature may be that the attachment means may include a ring sized to fit around the top of the vase. The ring may include a lip sized smaller that the top of the vase for resting on the top of the vase. Whereby, the ring may be positioned on the top of the vase with the ring around the top of the vase and the lip resting on the top of the vase.

Another feature may be the inclusion of thumb screws for securing the ring to the top of the vase.

Yet another feature may be where the resting place hook may include two arms that extend from the attachment means. Each of the two arms may have a hook or hooks. Wherein, the first arm may extend in the opposite direction of the second arm.

Another feature may be that the arms may extend a set distance from the attachment means.

Another feature may be that the arms may have a rounded top portion.

Another feature may be that the arms may have an angled top portion.

Another feature may be that the arms may have a horizontal top portion.

Another feature may be that the vase may include a ring plate mountable to a resting place marker, where the vase interlocks to the ring plate.

Another feature may be that the adornments hung from the hooks can be solar lights for lighting the vase, the resting place marker, the area around the resting place, or combinations thereof.

Yet, another feature may be that the resting place hook may be included as part of a resting place hook system. The resting place hook system may generally include a resting place marker, a vase mounted to the resting place marker, any of the various embodiments shown and described herein of the resting place vase hook attached to the vase. Whereby, an adornment or adornments may be hung from the hook or hooks in an elevated position.

One feature of the resting place hook system may be that the ring plate may be mountable to the resting place marker, where the vase interlocks to the ring plate.

Another feature of the resting place hook system may be that the ring plate can include a plurality of grooves, and the vase can include corresponding tabs, where the tabs are operable to be inserted and rotated in the grooves for mounting the vase to the ring plate.

In use, a method of decorating a resting place may utilize various embodiments of the resting place vase hook device, as shown and described herein. The method of decorating a resting place may include the steps of: providing any of the various resting place vase hook devices shown and described herein; attaching the provided resting place vase hook to a vase mounted on a resting place marker; and hanging an adornment from the hook in an elevated position.

One feature of the method of decorating a resting place may be, when the adornments are solar lights, the step of hanging the adornments from the hooks in an elevated position may include the steps of: hanging the solar lights from the hooks in an elevated position; and lighting the vase and resting place marker.

These and other features of the resting place vase hook and its method of use thereof will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present resting place vase hook device, system and method of use thereof will be better understood by reading the Detailed Description with reference to the accompanying drawings, which are not necessarily drawn to scale, and in which like reference numerals denote similar structure and refer to like elements throughout, and in which:

FIG. 1 is a perspective view of an exemplary embodiment of the resting place vase hook device;

FIG. 2 is a partially disassembled environment perspective view of another embodiment of the resting place vase hook device;

FIG. 3 is a front view of the embodiment of FIG. 1;

FIG. 4 is a side view of the embodiment of FIG. 1;

FIG. 5 is a front view of another embodiment of the resting place vase hook with a horizontal top portion;

FIG. 6 a front view of another embodiment of the resting place vase hook with an angled top portion;

FIG. 7 is an environmental perspective view of one embodiment of the resting place hook system;

FIG. 8 is a flow chart depicting an exemplary embodiment of the method of decorating a resting place.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

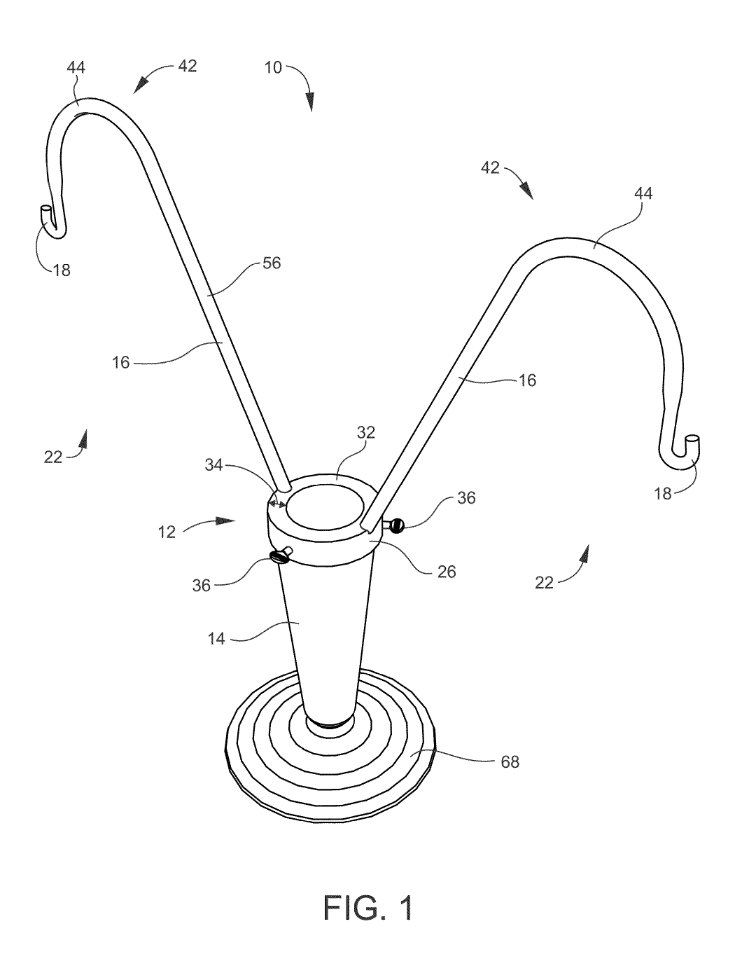

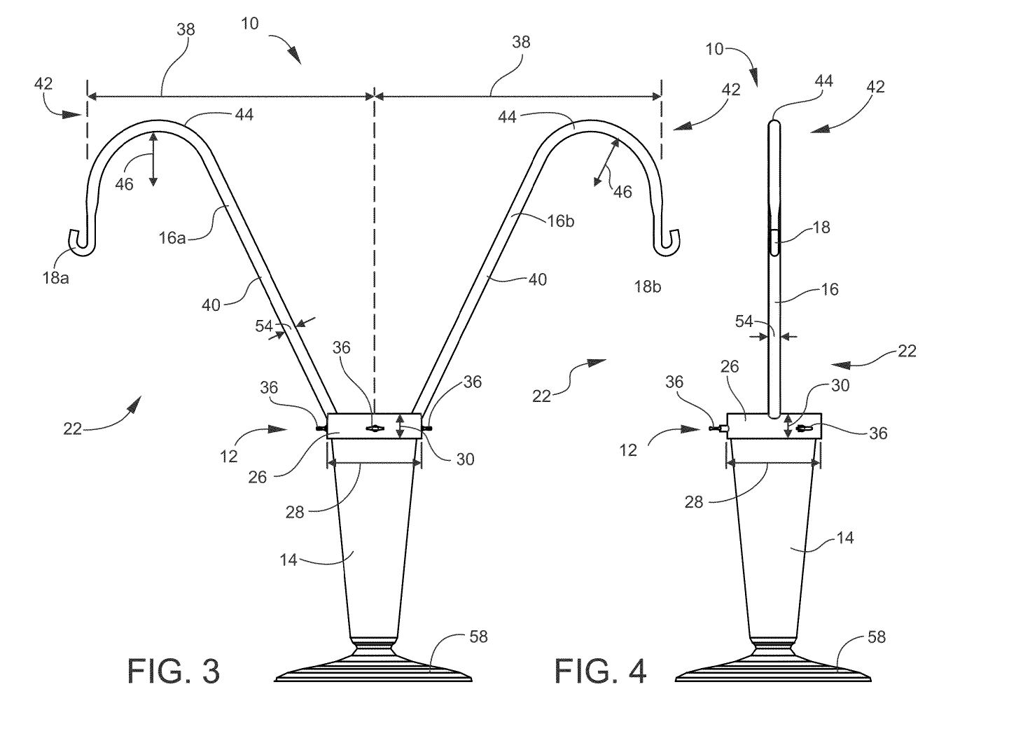

In describing the exemplary embodiments of the present disclosure, as illustrated in FIGS. 1-8, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-7 by way of example, and not limitation, therein is illustrated example embodiments of resting place vase hanger or resting place vase hook 10. As shown therein, resting place vase hook 10 generally comprises attachment means 12 and at least one arm 16. Attachment means 12 may be attachable to vase 14. Each arm 14 may extend from attachment means 12. Each arm 14 may have hook 18 or a plurality of hooks 18. Whereby, adornment 20, or a plurality of adornments 20, may be hung from hooks 18 in elevated position 22.

Elevated position 22 may be any desired position elevated from the ground, resting place, or resting place marker as desired. Elevated position 22 may prevent adornments 22 from touching the ground. This elevated position 22 may allow for adornments 20 to be hung around the resting place in compliance with local cemetery rules and regulations and/or may allow for easier lawn maintenance of the resting place and surrounding areas.

Attachment means 12 may be for attaching resting place vase hook 10 to vase 14, as shown herein, or to other desired objects or surfaces on or around the resting place. Attachment means 12 may be any device or mechanism for attaching resting place vase hook 10 to vase 14 or other desired objects or surfaces. Attachments means 12 may also de designed to attach resting place hook 10 anywhere or at any position on vase 14 or other desired objects or surfaces.

As shown in FIGS. 1-7, in select embodiments attachment means 12 may be attachable to the top 24 of vase 14. Attachment means 12 may be attachable to top 24 of vase 14 by any means, device or devices, where resting place vase hook 10 may be retrofitted to existing vases or other devices. In addition, attachment means 12 may be a permanent attachment to vase 14, or vase 14 and resting place vase hook 10 and vase 14 may be made integral, where attachment means 12 may be the integral connection between the two. In one embodiment, attachment means 12 may include ring 26 for attaching resting place vase hook 10 to the top 24 of vase 14. Ring 26 may be sized to fit around the top 24 of vase 14. Ring 26 may be made from any desired material, including, but not limited to being a metal ring. Ring 26 may also have any desired diameter 28 or thickness 30, which may vary depending on the size of vase 14. For example, when vase 14 may have approximately a 4 inch diameter around its top 24, ring 26 may have a 4.5 inch diameter 28, and may have thickness 30 of 1 and 3/16 inches. Ring 26 may be designed to fit securely around top 24 of vase 24 or may include additional securement and/or positioning means. In one embodiment, ring 26 may include lip 32 for aiding in positioning and/or securing ring 26 on the top 24 of vase 14. Lip 32 may be sized smaller than the top 24 of vase 14 for resting on the top 24 of vase 14. Whereby, ring 26 may be positioned on the top 24 of vase 14 with ring 26 around the top 24 of vase 14 and lip 32 resting on the top 24 of vase 14. Lip 32 may have any desired width 34. In one embodiment, width 34 of lip 32 may be ½ inch. Width 34 may be designed to rest securely on the top 24 of vase 14 while still allowing access to the interior of vase 14 for inserting flowers or other desired objects. In addition to lip 32, in select embodiments ring 26 may also include at least one thumb screw 36. Thumb screws 36 may be for positioning and/or securing ring 26 to vase 14. Ring 26 may include any desired number of thumb screws 36. In one embodiment, as shown in the Figures, ring 26 may include three thumb screws 36 equally spaced around ring 26 for securing and/or positioning ring 26 to the top 24 of vase 14.

Arm 16 or a plurality of arms 16 may be included in resting place vase hook 10. Each arm 16 may be for positioning hook 18, or a plurality of hooks 18, at elevated position 22. Arms 18 may be any device or combination of devices for positioning hook 18, or a plurality of hooks 18, at elevated position 22. In select embodiments, arms 16 may bee equally spaced around attachment means 12. This spacing may provide stability and balance to resting place vase hook 10 and vase 14. Each arm 16 may have hook 18, or a plurality of hooks 18, anywhere on arm 16. In select embodiments, each arm 16 may have a single hook 18 at its distal end. Arms 16 may be constructed of any desired material. For example, arms 16 may be made of rods, including rods with any size diameter 54. In one embodiment, arms 16 may be made of rods with diameter 54 being 3/16 inch, with hooks welded to the end.

As shown in the Figures, in select embodiments, resting place hook 10 may include two arms 16a and 16b that extend from attachment means 12. Each of arms 16a and 16b may have a corresponding hook 18a and 18b at their distal ends. Wherein, the first arm 16a may extend in the opposite direction of the second arm 16b. The arms 16a and 16b extending in opposite directions may provide equal spacing between the arms and help stabilize and balance resting place vase hook 10 and vase 14.

Each arm 16 may extend set distance 38 from attachment means 12. Set distance 38 may be any desired distance for creating any desired clearance from attachments means 12 and vase 14. In one embodiment, set distance 38 may be greater than 5 inches from attachments means 12 and vase 14. In another embodiment, set distance 38 may be between 5 inches and 15 inches from attachment means 12 and vase 14. In yet another embodiment, set distance 38 may be 13.5 inches from attachment means 12 and vase 14. Each arm 16 may have any desired length 40 for creating set distance 38. In one embodiment, length 40 of each arm 16 may be greater than 5 inches. In another embodiment, length 40 of each arm 16 may be between 6 inches and 25 inches. In yet another embodiment, length 40 of each arm 16 may be 21 inches.

Each arm 16 may also have any desired size or shape top portion 42. In one embodiment, as shown in FIGS. 1-4 and 7, top portion 42 may include rounded top portion 44. Rounded top portion 44 may include any size or shape, including any size radius 46 of curvature. In one embodiment, rounded top portion 44 may include a 3 inch radius 46 of curvature.

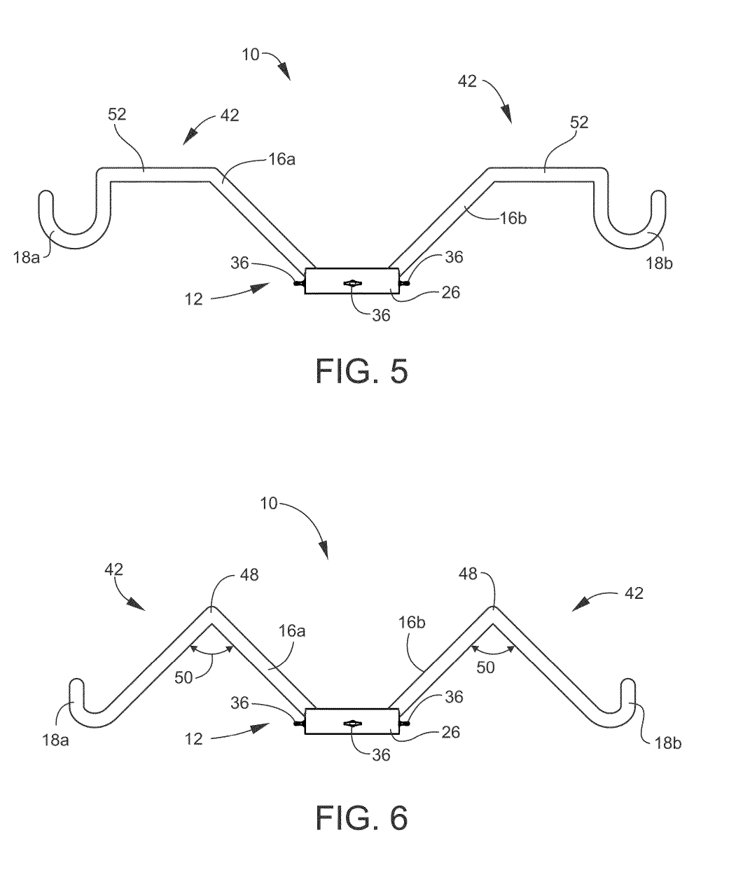

Referring to FIG. 5, in one embodiment top portion 42 of arms 16 may have horizontal top portion 52.

Referring to FIG. 6, in one embodiment top portion 42 of arms 16 may include angled top portion 48. Angled top portion 48 may include any desired angle 50. In one embodiment, angle 50 may be approximately 90 degrees.

Resting place vase hook 10 may be constructed of any desired material or thicknesses. In addition, resting place vase hook 10 may include any desired coating 56. For example, coating 56 may be an acid primer with a bronze paint.

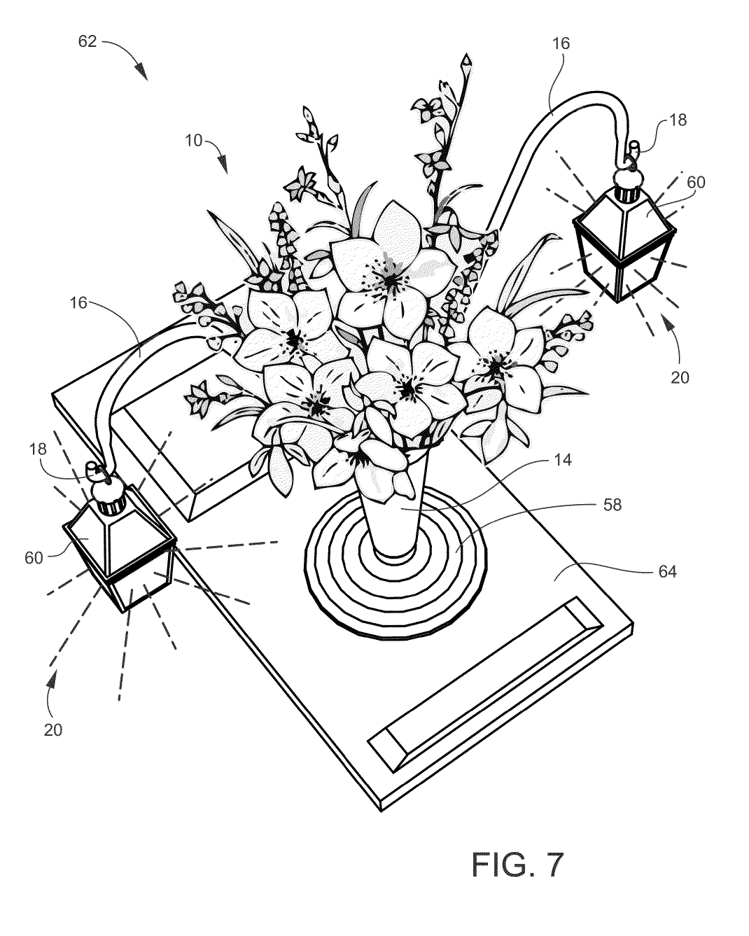

Adornments 20 may be hung from each hook 18 of resting place vase hook 10 at elevated position 22. See FIG. 7. Adornments 20 may be any desired adornments or other like devises, flowers, or memorabilia. As shown in FIG. 7, in one embodiment adornments 20 may be solar lights 60. Solar lights 60 may be hung from each hook 18 of resting place vase hook 10 at elevated position 22. Solar lights 60 may light up vase 14, resting place marker 64, and/or the surrounding area.

Referring to FIG. 7, resting place hook system 62 may include resting place vase hook 10. Any of the various embodiments of resting place vase hook 10, as shown and described herein, may be included as part of resting place hook system 62. Resting place hook system 62 may generally include resting place marker 64, vase 14 mounted to resting place marker 64, and resting place vase hook 10 attached to vase 14. Whereby, resting place vase hook 10 may be operable to hang adornment 20 or a plurality of adornments 20 in elevated position 22.

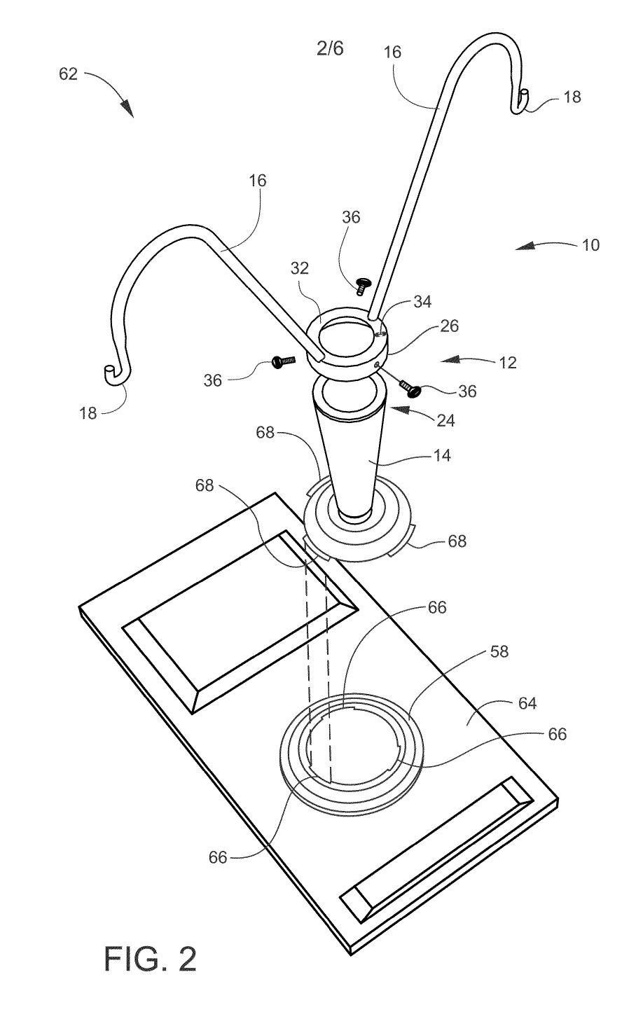

Vase 14 may be mounted to resting place marker 64 by any means. In select embodiments vase 14 may include ring plate 58 for mounting or attaching vase 14 to resting place marker 64. Ring plate 58 may be mountable to the resting place marker 64 by any means. Ring plate 58 and vase 14 may interlocks to mount vase 14 to resting place marker 64. In one embodiment, as shown in FIG. 2, ring plate 58 may include a plurality of grooves 66, and vase 14 may include corresponding tabs 68. Tabs 68 may be operable to be inserted and rotated in grooves 66 for mounting vase 14 to ring plate 58.

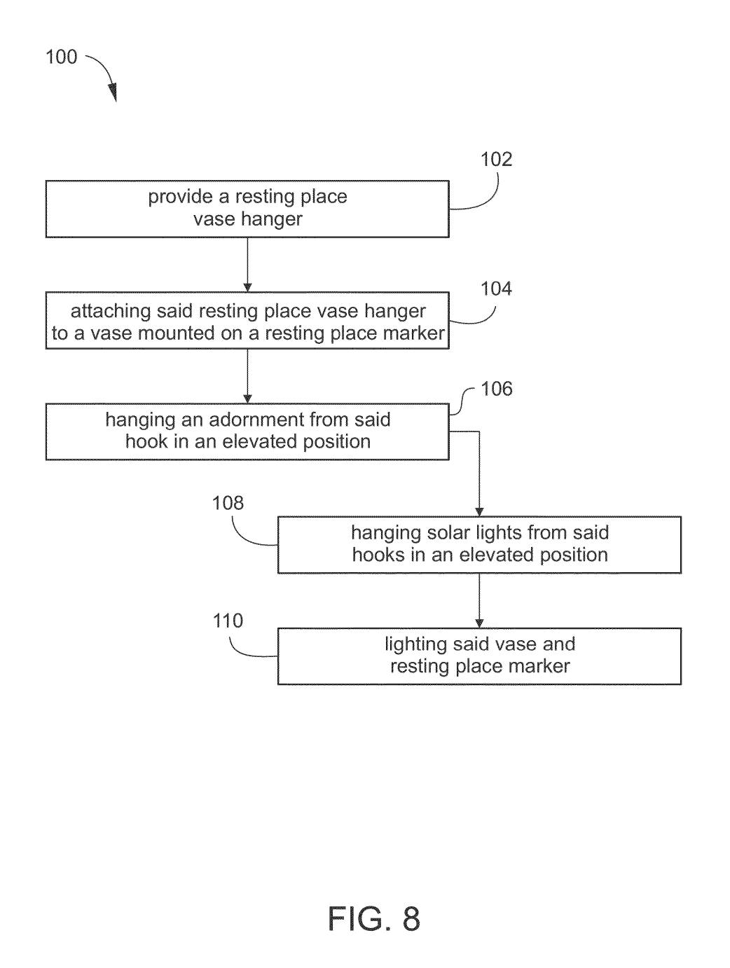

Referring now to FIG. 8, in use, method 100 of decorating a resting place may be conducted using various embodiments of resting place vase hook 10 as shown and described herein. Method 100 of decorating a resting place may generally include the steps of: step 102 of providing resting place vase hook 10 in any of the various embodiments shown and described herein; step 104 of attaching resting place vase hook 10 to vase 14 mounted on resting place marker 64; and step 106 of hanging adornment or a plurality of adornments 20 from hooks 18 in elevated position 22.

In one embodiment of method 100 of decorating a resting place, when adornments 20 may be solar lights 60, step 106 of hanging adornments 20 from hooks 18 in elevated position 22 may include the steps of: step 108 of hanging solar lights 60 from hooks 18 in elevated position 22; and step 110 of lighting vase 14 and resting place marker 64.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. A resting place vase hook, wherein said resting place vase hook comprises:
an attachment means attachable to a vase; and
at least one arm that extends from said attachment means each having at least one hook;
whereby, said hooks being operable to hang an adornment in an elevated position.

2. The resting place vase hook of claim 1 wherein said attachment means is attachable to the top of said vase,
wherein said attachment means comprises a ring sized to fit around the top of said vase.

3. The resting place vase hook of claim 2 wherein said ring includes a lip sized smaller that the top of said vase for resting on the top of said vase,
whereby, said lip being operable to position the ring on the top of the vase with said ring around the top of the vase and the lip resting on the top of the vase.

4. The resting place vase hook of claim 3 wherein said ring includes at least one thumb screw for securing said ring to the top of said vase.

5. The resting place vase hook of claim 4 wherein said ring includes three thumb screws equally spaced around said ring for securing said ring to the top of said vase.

6. The resting place vase hook of claim 1, wherein the resting place vase hook has a plurality of arms that extend from said attachment means, where each arm has at least one hook, wherein said plurality of arms are equally spaced around said attachment means.

7. The resting place vase hook of claim 1, wherein the resting place vase hook includes at least two arms, a first arm and a second arm that extend from said attachment means,
wherein each arm has a hook and said first arm extends in the opposite direction of said second arm.

8. The resting place vase hook of claim 1 wherein each of said at least two arms has a length and extends a set distance from said attachment means.

9. The resting place vase hook of claim 1 wherein said at least two arms having a rounded top portion.

10. The resting place vase hook of claim 1 wherein said at least two arms having an angled top portion.

11. The resting place vase hook of claim 1 wherein said at least two arms having a horizontal top portion.

12. The resting place vase hook of claim 1 wherein said vase including a ring plate mountable a resting place marker, where the vase interlocks to said ring plate.

13. The resting place vase hook of claim 1 wherein at least one adornment hangs from said hooks being solar lights.

14. A resting place hook system, wherein said resting place system comprises:
a resting place marker;
a vase mounted to said resting place marker; and
a resting place vase hook attached to said vase;
whereby, said resting place vase hook being operable to hang an adornment in an elevated position.

15. The resting place hook system of claim 14 wherein said vase including a ring plate mountable to the resting place marker, where the vase interlocks to said ring plate.

16. The resting place hook system of claim 15 wherein said ring plate including a plurality of grooves, and said vase including corresponding tabs, where said tabs are operable to be inserted and rotated in said grooves for mounting said vase to said ring plate.

17. The resting place hook system of claim 14 wherein said resting place vase hook includes:
an attachment means attachable to the top of said vase and comprises a ring sized to fit around the top of said vase;
said ring includes a lip sized smaller that the top of said vase for resting on the top of said vase;
whereby, said lip being operable to position the ring on the top of the vase with said ring around the top of the vase and the lip resting on the top of the vase;
said ring includes three thumb screws equally spaced around said ring for securing said ring to the top of said vase; and
at least one arm that extends from said attachment means, each arm having at least one hook.

18. The resting place hook system of claim 14 wherein at least one adornment hangs from said hooks being solar lights.

19. A method of decorating a resting place including the steps of:
providing a resting place vase hook that comprises:
an attachment means attachable to a vase; and
at least one arm that extends from said attachment means having a hook;
attaching said resting place vase hook to a vase mounted on a resting place marker; and
hanging at least one adornment from said hook in an elevated position.

20. The method of decorating a resting place of claim 19 wherein said at least one adornment is a solar lights, whereby said step of hanging said at least one adornment from said hook in an elevated position including the steps of:
hanging said solar lights from said hooks in an elevated position; and
lighting said vase and resting place marker.
